(19) United States
(12) Patent Application Publication
(10) Pub. No.: US 2011/0148847 A1
(43) Pub. Date: Jun. 23, 2011

(54) METHOD OF DRIVING DISPLAY APPARATUS

(75) Inventor: Kouji Ikeda, Chiba-shi (JP)

(73) Assignee: CANON KABUSHIKI KAISHA, Tokyo (JP)

(21) Appl. No.: 12/970,546

(22) Filed: Dec. 16, 2010

(30) Foreign Application Priority Data
Dec. 21, 2009 (JP) 2009-289726
Nov. 16, 2010 (JP) 2010-256309

(51) Int. Cl. G06F 3/038

(52) U.S. Cl. 345/212

(57) ABSTRACT

The display apparatus includes a light emitting element, a transistor that determines a current supplied from a power supply line to the light emitting element depending on a gate voltage of the transistor, a capacitor that holds the gate voltage of the transistor, a first circuit unit configured to allow the capacitor to hold a voltage of a data line, and a switch operable to cut off the current. The display apparatus further includes a second circuit unit that operates such that when a change occurs in voltage across the light emitting element as a result of turning off the current, a voltage proportional to the difference in the voltage across the light emitting element with respect to the voltage obtained before the current was cut off is added to the voltage held in the capacitor, and a resultant voltage is applied to the gate of the transistor.

### BACKGROUND OF THE INVENTION

1. Field of the Invention

The present invention relates to a method of driving a display apparatus including a light emitting element.

2. Description of the Related Art

In an emissive display apparatus such as an organic electroluminescence (EL) display apparatus, a plurality of pixels each including a light emitting element are disposed in the form of a matrix on a substrate. To allow the light emitting element of each pixel to emit light with luminance exactly corresponding to image data, a current flowing through the light emitting element is precisely controlled.

The display apparatus has pixel circuits provided for respective pixels. Each pixel circuit includes circuit elements such as a thin film transistor (TFT), a capacitor, etc. To sequentially select pixel circuits on a row-by-row basis and write data into them, there are disposed control signal lines each of which is connected to pixel circuits located in corresponding one of rows thereby to control pixel circuits on the row-by-row basis. There are also disposed data lines each of which is connected to pixel circuits located in corresponding one of columns thereby to transmit image data to pixels.

Long-term use of the organic EL element tends to produce a reduction in luminance due to degradation depending on the cumulative amount of current passed through the organic EL element. The reduction in luminance of the organic EL element due to the current passed therethrough is irreversible. That is, once an organic EL element has a reduction in luminance, the luminance will never go back to its original value. Japanese Patent Laid-Open No. 2006-91709 discloses a technique to compensate for a reduction in luminance with time. More specifically, in this technique, a voltage that appears across an organic EL element when a current is passed through the organic EL element is detected by a detection circuit and recorded in a memory, and image data is corrected in accordance with the recorded voltage appearing across the organic EL element.

In the technique in which the voltage across the organic EL element is read by an external circuit and the image data is corrected in accordance with the read voltage, it is necessary to dispose an additional circuit in each pixel circuit to read the voltage across the organic EL element and output the read voltage to the outside of the pixel circuit. Because the reading of the voltage across the organic EL element is performed in a period different from a period in which an image is displayed, a memory is necessary to store the read voltage across the organic EL element for each of all pixels, and an additional circuit is necessary to calculate a correction value from the voltage stored in the memory.

### SUMMARY OF THE INVENTION

The present invention provides a method of driving a display apparatus including a pixel circuit configured to automatically correct a voltage across a light emitting element for each pixel.

According to an aspect of the present invention, there is provided a method of driving a display apparatus including a light emitting element including a light emitting layer disposed between a pair of electrodes, a pixel circuit connected to a data line and a power supply line, a constant voltage power supply connected to the power supply line, and a second switch disposed in a current path from the constant voltage power supply to one of the electrodes of the light emitting element, wherein the pixel circuit includes a transistor a source of which is connected to the power supply line and which supplies a current from its drain to the one of the electrodes of the light emitting element, a first capacitor one end of which is connected directly or indirectly via a capacitor to a control node connected directly or indirectly via a capacitor to a gate of the transistor, a first switch connected between the data line and the control node, and a series connection of a third switch and a second capacitor connected between the control node and the one of the electrodes of the light emitting element, the method comprising turning on the first switch, the second switch, and the third switch thereby supplying a current to the light emitting element, setting the control node to have a voltage equal to a data voltage of the data line, and holding, across the second capacitor, a potential difference between the one of the electrodes of the light emitting element and the control node, turning off the second switch thereby cutting off the current flowing through the light emitting element whereby a change occurs in potential of the one of the electrodes of the light emitting element and this change in the potential of the one of the electrodes of the light emitting element produces a change in the potential of the control node via the second capacitor, and turning off the third switch and turning on the second switch thereby supplying a current corresponding to a gate potential of the transistor to the light emitting element.

In the method of driving the display apparatus according to the aspect of the present invention, the current passed through the light emitting element is increased depending on an increase in voltage across the light emitting element due to degradation with time thereby compensating for the reduction in luminance due to the degradation within each pixel circuit without needing an additional memory or an external correction circuit.

Further features of the present invention will become apparent from the following description of exemplary embodiments with reference to the attached drawings.

### BRIEF DESCRIPTION OF THE DRAWINGS

FIG. 1 is a diagram illustrating a pixel circuit of a display apparatus according to an embodiment of the present invention.

FIG. 2 is a diagram illustrating a whole display apparatus according to an embodiment of the present invention.

FIG. 3 is a timing chart illustrating an operation of a pixel circuit according to an embodiment of the present invention.

FIG. 4A illustrates a V-I characteristic of a light emitting element in an original state and a V-I characteristic in a degraded state, and FIG. 4B illustrates a change in luminance with time.

FIG. 5 is a diagram illustrating a pixel circuit of a display apparatus according to a modified embodiment of the present invention.

FIG. 6 is a diagram illustrating a pixel circuit of a display apparatus according to an embodiment of the present invention.

FIG. 7 is a timing chart illustrating an operation of a pixel circuit according to an embodiment of the present invention.

FIG. 8 is a timing chart illustrating an operation of a pixel circuit according to an embodiment of the present invention.

FIG. 9 is a diagram illustrating a pixel circuit of a display apparatus according to an embodiment of the present invention.

FIG. 10 is a timing chart illustrating an operation of a pixel circuit according to an embodiment of the present invention.

FIG. 11 is a diagram illustrating a pixel circuit of a display apparatus according to a modified embodiment of the present invention.

FIG. 12 is a block diagram illustrating a total configuration of a digital still camera according to an embodiment of the present invention.

### DESCRIPTION OF THE EMBODIMENTS

The present invention is described in further detail below with reference to embodiments. In the embodiments described below, it is assumed merely by way of example that the display apparatus is an organic EL display apparatus. Note that the present invention may be applied to display apparatuses using other types of light emitting elements such as an inorganic EL element, an LED, etc.

### First Embodiment

### Configuration of Pixel Circuit

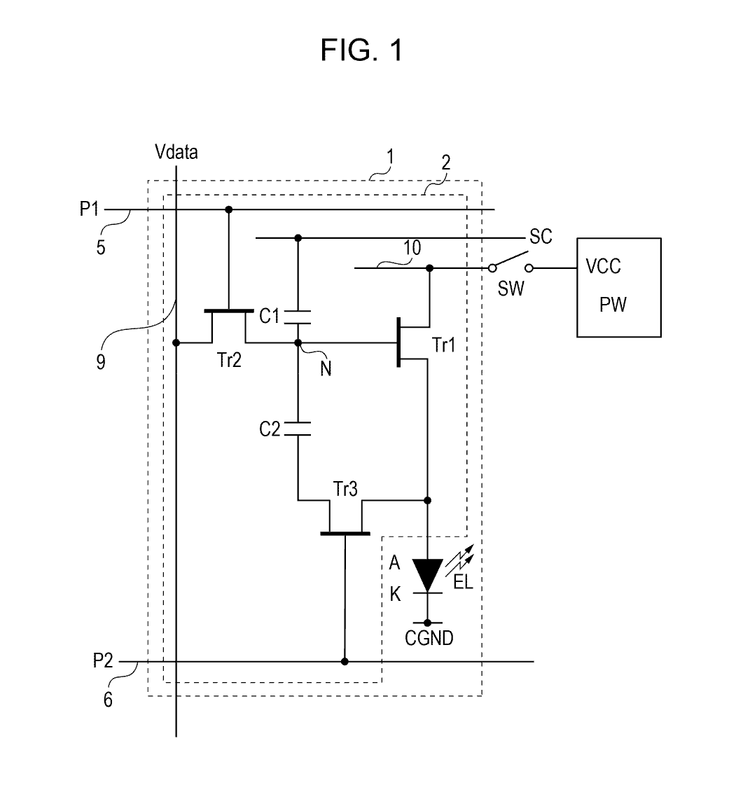

FIG. 1 illustrates a pixel and associated wirings connected thereto in a display apparatus according to a first embodiment of the present invention. The pixel 1 includes a pixel circuit 2 and a light emitting element EL.

The pixel circuit 2 are connected to two control signal lines 5 and 6 and one data line 9. Control signals P1 and P2 for selecting a row is input to the pixel circuit 2 via the two control signal lines 5 and 6. In synchronization with these signals, a data voltage Vdata is input as gray level data via the data line 9.

A first transistor Tr1 functions as a driving transistor that supplies a current to the light emitting element. A source of the first transistor Tr1 is connected to a power supply line 10 and a drain thereof is connected to an anode of the light emitting element EL.

In the present description, the source and the drain of the transistor are defined such that when the transistor turns on or off depending on a potential difference between a gate and a terminal of the transistor, this terminal is referred to as the source, and the other terminal is referred to as the drain. In the case where the transistor is of a P-channel type, the current flows from the source to the drain. When the current flows in an opposite direction, roles of the electrodes are exchanged between the source and the drain.

A second transistor Tr2 is an N-channel type transistor functioning as a first switch that connects the data line 9 to the gate of the first transistor Tr1. The second transistor Tr2 turns on when the control signal P1 rises up to an “H” (high) level. When the second transistor Tr2 turns on, the potential Vdata on the data line 9 is captured into the pixel circuit 2. In a case where the data line potential Vdata is higher than a gate potential of the first transistor Tr1, the terminal of the second transistor Tr2 connected to the data line 9 functions as the drain while the terminal connected to the gate of the first transistor Tr1 functions as the source, and a current flows from the data line 9 toward the gate of the first transistor Tr1. On the other hand, in a case where the data line potential Vdata is lower than the gate potential of the first transistor Tr1, a current flows in an opposite direction. In this case, the source and the drain function reversely. Hereinafter, for convenience, when the data line potential Vdata is lower than the gate potential of the first transistor Tr1, the first transistor Tr1 is said to be in a normal state, and the terminal connected to the data line 9 is referred to as the source, while the terminal connected to the gate of the first transistor Tr1 is referred to as the drain.

One end of the capacitor C1 is connected to a control node N that is a node between the gate of Tr1 and the drain of Tr2, while the other end of the capacitor C1 is connected to a constant potential SC. The capacitor C1 functions to hold the gate-source voltage of the first transistor Tr1.

A third transistor Tr3 is an N-channel type transistor which is connected in series to a second capacitor C2. The third transistor Tr3 functions as a switch that is located between the control node N (the node between the gate of Tr1 and the drain of Tr2) and the anode terminal of the light emitting element EL and that turns on/off in accordance with the control signal P2. The third transistor Tr3 and the capacitor C2 are provided to feed a change in the voltage across the light emitting element EL caused by a change in the current flowing through the light emitting element EL back to the gate of the driving transistor.

The light emitting element EL includes two electrodes, i.e., an anode (A) and a cathode (K), and also includes an organic EL light emission layer disposed between the anode (A) and the cathode (K). Either the anode or the cathode of the light emitting element EL is connected to the pixel circuit 2. In the example shown in FIG. 1, the anode is connected to the drain electrode of Tr1 in the pixel circuit 2 while the cathode is connected to a ground potential GND. Alternatively, the light emitting element EL may be connected oppositely such that the anode is grounded. In this case, a current flows in a direction from the light emitting element EL to the transistor Tr1.

In the present description, any voltage is defined with respect to the ground potential GND connected to an electrode of the light emitting element opposite to an electrode connected to the pixel circuit.

The pixel circuit 2 is connected to a power supply line 10 to which a constant voltage VCC is supplied from a constant voltage power supply PW. The power supply voltage VCC is supplied to each pixel circuit 2 via the power supply line 10 extending in a row direction or a column direction.

In the present embodiment, the pixel circuit includes a switch SW provided for each power supply line 10 extending in the row or column direction to turn on or off the connection between the power supply line 10 and the constant voltage power supply thereby turning on or off the current flowing through the light emitting element EL. Although the switch SW is disposed between the power supply line 10 and the constant voltage power supply in the present embodiment, the switch SW may be disposed at any location in a current path between the constant voltage power supply and the light emitting element EL. Hereinafter, the switch SW will be referred to as a second switch, and the third transistor Tr3 will be referred to as a third switch.

### Configuration of Display Apparatus

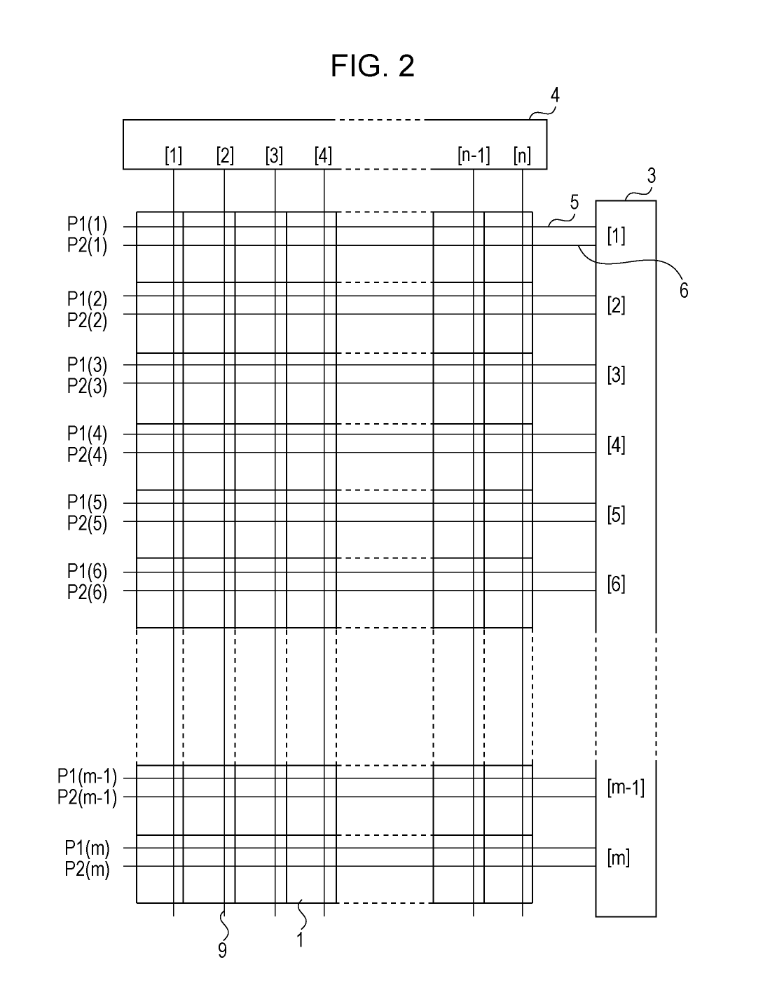

Each pixel circuit 2 is connected to two control signal lines extending in the row direction and one data line extending in the column direction. Pixels 1 each including light emitting elements EL and pixel circuits 2 are disposed in the row and column directions in the form of a matrix such that an active matrix display apparatus is formed as shown in FIG. 2.

In the active matrix display apparatus of the example shown in FIG. 2, pixels 1 are arranged in the form of a two-dimensional matrix having m rows and n columns. Each pixel 1 includes three light emitting elements EL respectively configured to emit 3 colors, i.e., red (R), green (G), and blue (B) and three pixel circuits 2 that supply currents to the respective light emitting elements EL. In FIG. 2, only n data lines 9 are shown. However, actually, each pixel is connected to three data lines of R, G, and B, and thus the actual total number of data lines is 3n.

Although not shown in FIG. 2, there are a plurality of power supply lines 10 extending in the row or column direction. A row control circuit 3 and a column control circuit 4 are disposed in an area surrounding the array of pixels. Signal lines extend from the row control circuit 3 such that each row has two signal lines. Control signals P1(1) to P1 (m) and P2(1) to P2(m) are output to m rows of signal lines. A first control signal P1 of each row is input to pixel circuits 2 in the row via a corresponding P1 signal line (first control signal line) 5. A second control signal P2 of each row is input to pixel circuits 2 in the row via a corresponding P2 signal line (second control signal line) 6. The column control circuit 4 is supplied with an image signal and outputs data voltages Vdata from a total of 3n output terminals. The data voltages Vdata have values corresponding to gray levels, and are input to the pixel circuits in the respective columns via the data lines 9.

### Circuit Operation

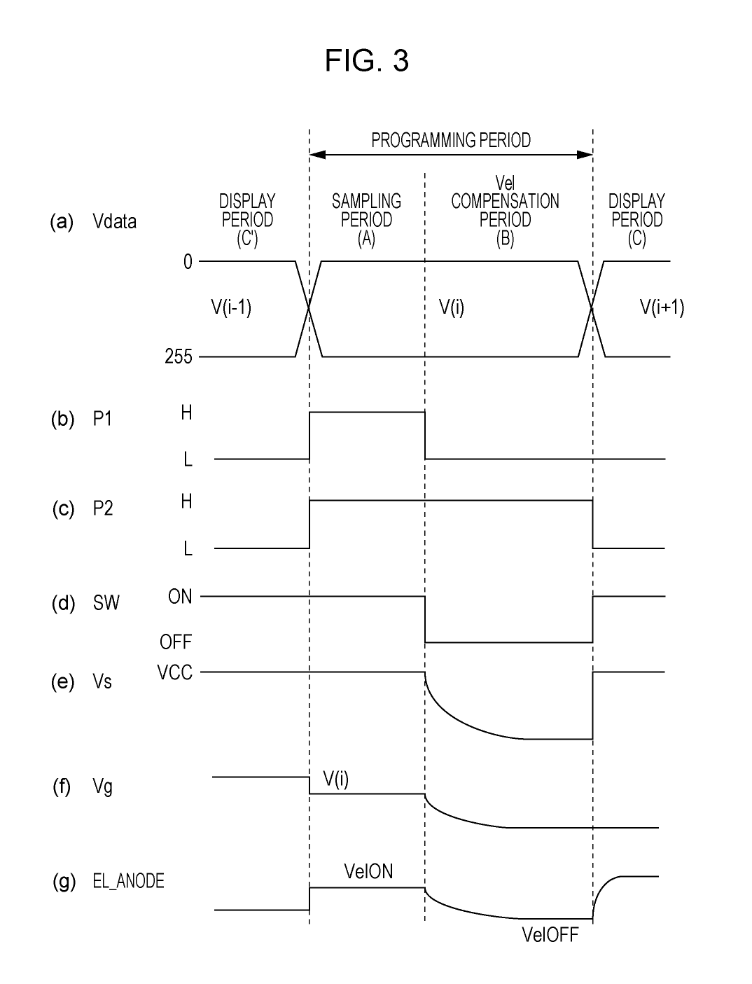

FIG. 3 is a timing chart illustrating an operation of the pixel circuit 2 shown in FIG. 1. In this timing chart, it is assumed that the pixel circuit 2 is located in an i-th row. In FIG. 3, part (a) indicates the data signal Vdata on the data line, part (b) indicates the control signal P1(i) on the signal line P1 in the i-th row, part (c) indicates the control signal P2(i) on the P2 signal line in the i-th row, part (d) indicates the on/off state of the switch SW, part (e) indicates the source voltage Vs of the transistor Tr1, part (f) indicates the gate voltage Vg of the transistor Tr1, and part (g) indicates the anode voltage of the light emitting element EL. Note that all voltages are defined with respect to the cathode of the light emitting element EL.

Before a programming period for the i-th row, the operation has a programming period for an (i−1)th row, and the operation has a programming period for an (i+1)th row after the programming period for the i-th row. In the programming period for the (i−1)th row, a data signal V(i−1) is supplied via the data line, while a data signal V(i+1) is supplied in the programming period for the (i+1)th row.

Each programming period has two sub-periods, i.e., sampling period (period A) in which graylevel data is captured into the pixel circuit and a Vel compensation period (period B) in which a Vel compensation is performed according to the present embodiment of the invention. In each pixel, image data is programmed during each programming period and the pixel emits light during a display period (period C) following the programming period. A display period (period C′) immediately before the programming period is a period in which light is emitted according to data written in the previous programming period. In the example shown in FIG. 3, light emission is continued from one programming period to a next programming period. However, depending on a situation, light emission may be stopped and light may not be emitted in a following period.

Operations in respective periods (A) to (C) will be described in further detail below.

### Sampling Period (Period A)

In the sampling period (period A), the switch SW is turned on whereby the power supply VCC is connected to the pixel circuit 2 and thus the source voltage (Vs) of the transistor Tr1 becomes equal to VCC. A data voltage Vdata (V(i)) for the pixel (located in the i-th row) is supplied from the column control circuit 4 to the data line 9.

A signal P1(i)=“H” (high level) is supplied to the P1 signal line in the i-th line and a signal P2(i)=“H” is supplied to the P2 signal line in the i-th row. The transistor Tr2 functioning as the first switch turns on in response to the signal P1(i)=“H” supplied via the P1 signal line in the i-th row, and the transistor Tr3 functioning as the third switch turns on in response to the signal P2(i)=“H” supplied via the P2 signal line in the i-th row. As a result, the data voltage Vdata V(i) is transmitted via the transistor Tr2 to the control node N that is directly connected to the gate of the transistor Tr1 and one terminal of the capacitor C1, and the data voltage Vdata V(i) is sampled by the pixel circuit 2. Thus, the potential difference between the anode of the light emitting element EL and the control node N is held in the second capacitor.

The sampled voltage V(i) causes the gate-source voltage Vgs=Vs−Vg of the transistor Tr1 to be equal to VCC−V(i). If this gate-source voltage Vgs is higher than the threshold voltage Vth of the transistor Tr1, a drain current flows through the transistor Tr1 depending on an excess of the gate-source voltage Vgs=Vs−Vg relative to the threshold voltage Vth. More specifically, the drain current is determined by a value equal to VCC−V(i)−Vth as shown in a following equation (1).

I=β(VCC−V(i)−Vth)² (1)

where β is a constant depending on characteristics of the transistor Tr1. A current equal to the drain current described above flows through the light emitting element EL.

When the current flows through the light emitting element EL, the anode voltage VelON is determined by a V-I characteristic of the light emitting element EL, i.e., the anode voltage VelON depends on a relationship between the current I flowing through the light emitting element EL and the voltage Vel across the light emitting element EL as described below in equation (2).

VelON=Vel(I) (2)

Thus, the capacitor C2 is charged to a voltage equal to V(i)−VelON.

### Vel Compensation Period (Period B)

When the voltage on the P1 signal line changes from “H” to “L” (low level), the transistor Tr2 turns off, and the sampling period ends and the Vel compensation period (period B) starts. In response, the second switch SW turns off and the current flowing through the light emitting element EL is cut off. The P2 signal line is maintained at “H” and thus the transistor Tr3 remains in the on-state.

After the switch SW turns off, the drain voltage of the transistor Tr1 drops down toward the off-voltage VelOFF of the light emitting element EL. Although the gate voltage also drops down, the second transistor Tr2 has been in the off-state since the end of the sampling period, and thus the charge stored on the positive electrode of the capacitor C1 and the charge stored on the negative electrode of the capacitor C2 remains therein without going away. The total charge is given by equation (3) shown below.

=C1(VCC−V(i))+C2(V(i)−VelON) (3)

Therefore, when the anode voltage of the light emitting element has changed and finally settled at a value equal to the off-voltage VelOFF in the Vel compensation period as shown in parts (f) and (g) in FIG. 3, the gate voltage Vg of the transistor Tr1 is given by equation (4) shown below.

Vg=V(i)−(C2/(C1+C2))(VelON−VelOFF) (4)

That is, in this state, the gate voltage Vg is lower than V(i) given via the data line, and the difference is equal to the change in voltage across the light emitting element EL (i.e., VelON−VelOFF) times a ratio of capacitance (i.e., C2/(C1+C2)). This voltage is given to the pixel circuit as the programmed voltage for the i-th row. The programmed voltage is applied to the gate of the first transistor Tr1 thereby determining the current flowing through the light emitting element EL.

In the present embodiment, as described above, the data voltage V(i) is not directly employed as the programmed voltage, but, instead, the data voltage V(i) plus the voltage proportional to the change in voltage across the light emitting element EL is employed as the programmed voltage so that the change in voltage across the light emitting element EL due to degradation of the light emitting element EL is fed back to the gate voltage whereby the reduction in luminance due to the degradation is compensated for by the increase in current. The compensation for the reduction in luminance will be discussed in further detail later.

### Display Period (Period C)

After the gate voltage of the transistor Tr1 has changed and settled at the voltage described above and the programming has been completed, the P2 signal line is switched from “H” to “L” to turn off the transistor Tr3.

The turning-off of the transistor Tr3 causes the gate of the transistor Tr1 to be disconnected from the anode of the light emitting element EL. However, because the charge on the capacitor C1 remains unchanged, the gate voltage Vg remains at the value given by equation (4). If the switch SW connected between the power supply and the pixel is again turned on while maintaining the transistor Tr3 in the off-state, then the source voltage Vs of the transistor Tr1 becomes equal to VCC and the transistor Tr1 is turned on with a conduction level dependent on the gate voltage Vg given by equation (4). The gate voltage Vg in the display period given by equation (4) is lower than the gate voltage V(i) in the sampling period, and thus a greater current flows through the light emitting element EL in the display period than in the sampling period, and the anode voltage of the light emitting element EL becomes higher than VelON.

That is, as described above, the programmed voltage is given as follows. First, the data voltage given via the data line is sampled in the pixel circuit. After the sampling is completed, the switch SW is once disconnected from the source of the driving transistor (transistor Tr1) and the gate of the driving transistor (transistor Tr1) is disconnected from the light emitting element. In this state, if the switch SW is again turned on, the gate potential of the driving transistor (transistor Tr1) becomes lower by the amount dependent on the voltage across the light emitting element EL, and this gate voltage is finally given as the programmed voltage. When the programming is complete, the gate-source voltage of the driving transistor (transistor Tr1) is equal to the data-source voltage obtained by sampling the voltage on the data line plus the change in voltage of the light emitting element EL, and thus the absolute value of the gate-source voltage is greater than that obtained before the programming.

The current flowing through the light emitting element EL in the display period is determined by the programmed voltage, i.e., by the gate voltage of the driving transistor (transistor Tr1) in the state in which the gate potential has dropped down. This current flowing in this situation is greater than the current determined by the original data voltage sampled in the above-described manner. The relationship between the current Iel passed through the light emitting element EL and the emitted-light luminance L can be known in advance by a measurement. Thus, the data voltage V(i) can be set such that when the current is passed through the light emitting element EL, the light emitting element EL emits light with luminance equal to the correct luminance expected by the image data.

Although the data voltage V(i) itself does not directly determine the emitted light luminance, the data voltage V(i) may be set to be close to the final programmed voltage. The change in voltage across the light emitting element EL (i.e., VelON−VelOFF) originates from the current flowing at the gate voltage of V(i). If this current is much smaller than the current flowing through the light emitting element EL when light is emitted, a great amount of pulling-down of the gate potential is necessary, which can cause a reduction in accuracy.

### Compensation for Reduction in Luminance

As described above, long-term use of the organic EL element can cause a change in V-I characteristic which can cause a reduction in luminance. In the case of the organic EL display apparatus having a large number of pixels, each pixel has different history in terms of light emission, i.e., the change in luminance with time is different for each pixel even if all pixels initially have similar characteristics. Even if emission of light is stopped, the reduced luminance does not go back to the original value because the reduction is caused by degradation of the organic EL element.

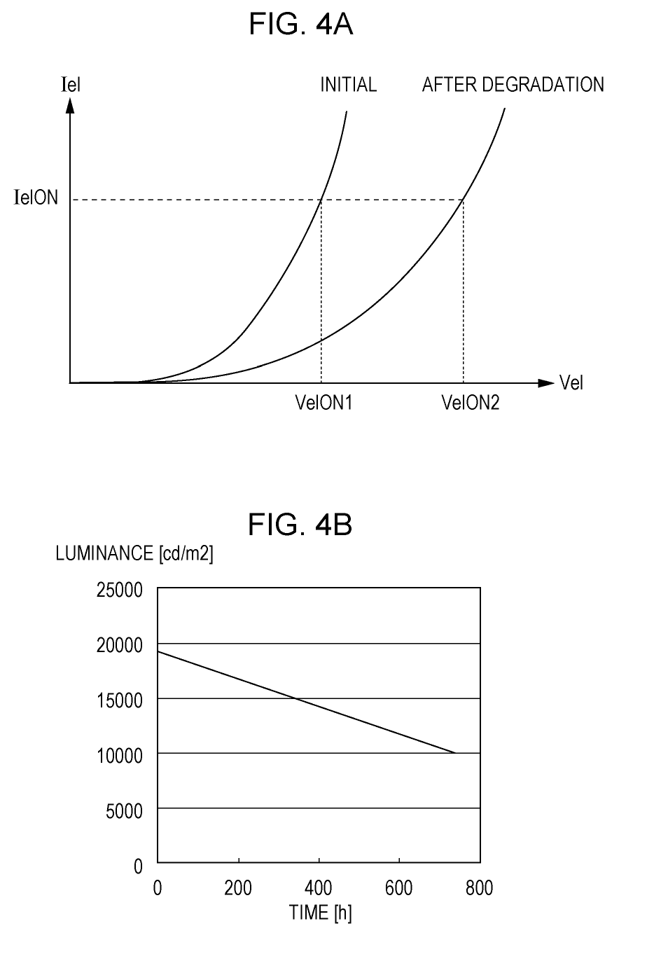

FIG. 4A illustrates an example of a change in V-I characteristic caused by long-term use of a light emitting element EL. A change in V-I characteristic can cause an increase in voltage across the light emitting element EL necessary for the same amount of current. FIG. 4B illustrates an example of a change in luminance as a function of time for a case where a constant current is continuously passed through a light emitting element EL. As can be seen, the luminance decreases with time.

In the pixel circuit according to the present embodiment of the invention, the gate voltage level (the gate potential) is lowered by an amount equal to a change in voltage across the light emitting element EL, and thus an increase in voltage of the light emitting element EL due to degradation leads to an increase in the amount of the lowering of the gate voltage level, which is fed back so as to increase the current flowing through the light emitting element EL. As a result, the reduction in luminance due to the degradation of the light emitting element EL is suppressed.

Because there is no difference in current IelON flowing through the light emitting element EL for the same data voltage V(i) during the sampling period A regardless of degradation, the amount of the change in voltage across the light emitting element EL due to degradation is equal to the amount of a change in voltage necessary to obtain the same current IelON, i.e., equal to the difference from VelON1 to VelON2 shown in FIG. 4A. The value of this voltage difference is multiplied by a factor k=C2/(C1+C2), and the resultant value is fed back to the gate of the transistor Tr1. Thus, the current in the display period is given as follows.

I1=β(VCC−V(i)−Vth+k(VelON1-VelOFF1))²

for the initial state,

I2=β(VCC−V(i)−Vth+k(VelON2-VelOFF2))²

for the degraded state.

The voltage VelON2 applied across the light emitting element after the degradation is greater than the voltage VelON1 applied across the light emitting element before the degradation, and the current of the transistor Tr1 increases from I1 to I2 depending on the difference between VelON2 and VelON1. By determining the coefficient k such that the increase in the current causes the luminance to increase by the amount equal to the reduction in the luminance due to the degradation, it is possible to compensate for the reduction in luminance caused by the degradation of light emitting element EL due to aging without having to correct the data voltage V(i). It is possible to set the coefficient k to an arbitrary value from 0 to 1 by setting the capacitance ratio of C1 to C2.

Note that the correction amount of the current also depends on the data voltage because the change in the voltage across the light emitting element EL depends on the data voltage. That is, the correction of the current is performed not by a constant amount but by an amount depending on the level of the graylevel signal V(i). In a conventional technique in which the voltage across a light emitting element is detected and the detected value is transmitted to an external circuit, a sufficiently long time is not available to detect the voltage across the light emitting element. Therefore, a voltage that appears across the light emitting element when a fixed current is passed through the light emitting element is detected, and, based on this detected value, correction voltages for all gray levels are calculated. In contrast, in the present embodiment of the invention, a correction current can be exactly determined for any gray level and thus high accuracy can be achieved in the correction.

In the present embodiment of the invention, the difference between the anode voltage in the state in which a current is passed through the light emitting element EL and the anode voltage in the state no current is passed through the light emitting element EL is automatically fed back to the gate voltage of the driving transistor in the pixel circuit such that the current is increased to cancel out the reduction in the luminance due to degradation. By detecting the EL element voltage and recording it in the memory for each pixel, it is possible to compensate for the reduction in luminance due to degradation on a pixel-by-pixel basis without having to correct the data.

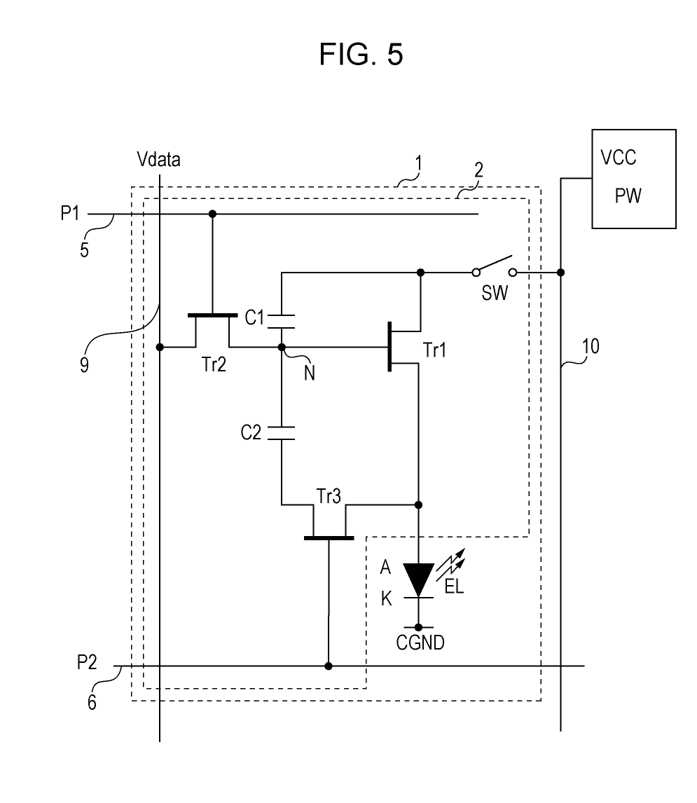

FIG. 5 illustrates a modification of the present embodiment of the invention. This modification is achieved from the circuit shown in FIG. 1 by moving the location of the switch SW into the inside of the pixel circuit 2 such that the switch SW is disposed between the power supply line 10 and the source of the first transistor Tr1, and furthermore removing the constant voltage line SC and connecting the other terminal (opposite to the terminal connected to the gate of Tr1) of the capacitor C1 to the source of the first transistor Tr1. Other similar elements to those in FIG. 1 are denoted by similar reference symbols. The operation is performed in a similar manner to that described above with reference to the timing chart shown in FIG. 3. The disposing of the switch SW inside the pixel circuit 2 results in a reduction in switching current, and thus it becomes possible to reduce the size of the switch SW.

### Second Embodiment

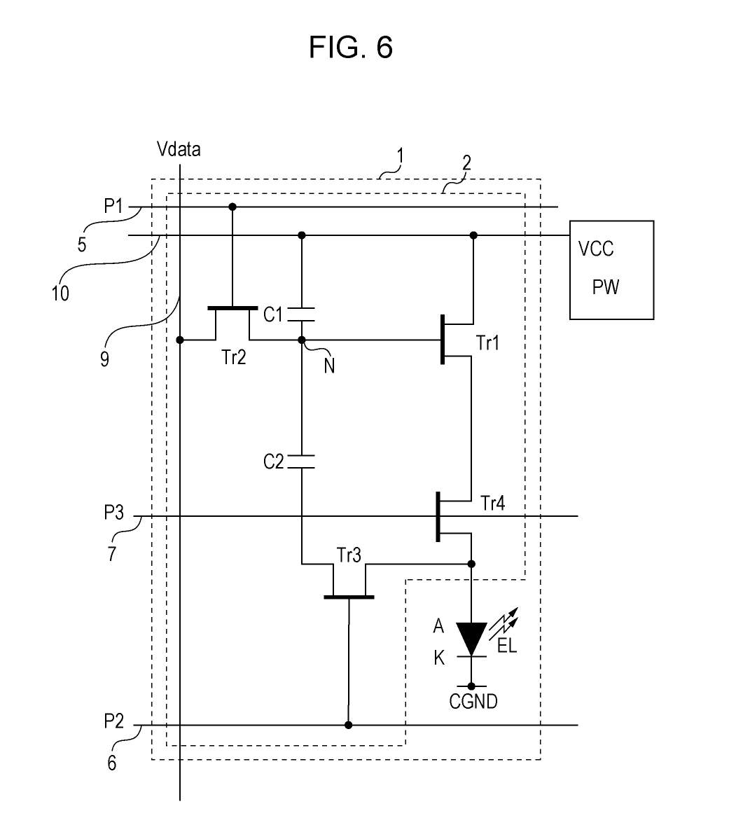

FIG. 6 illustrates a pixel circuit 2 of a display apparatus according to a second embodiment of the present invention.

In the pixel circuit according to the second embodiment, the second switch SW used in the first embodiment is removed, and, instead, a fourth transistor Tr4 is disposed between the drain of the first transistor Tr1 and the anode of the light emitting element EL and furthermore an additional P3 signal line 7 is provided to supply a signal to the gate of the fourth transistor Tr4. The other circuit elements are similar to those in the pixel circuit according to the first embodiment, and these similar circuit elements are denoted by similar reference numerals to those in the first embodiment. A total configuration of the display apparatus is similar to that shown in FIG. 2 except that respective rows have additional P3 signal lines P3(1) to P3(m).

The fourth transistor Tr4 is provided instead of the switch SW in the first embodiment and functions as the second switch that turns on and off the current flowing through the light emitting element EL. Instead of locating the fourth transistor Tr4 as in FIG. 5, the fourth transistor Tr4 may be connected between the power supply line 10 and the source of the first transistor Tr1.

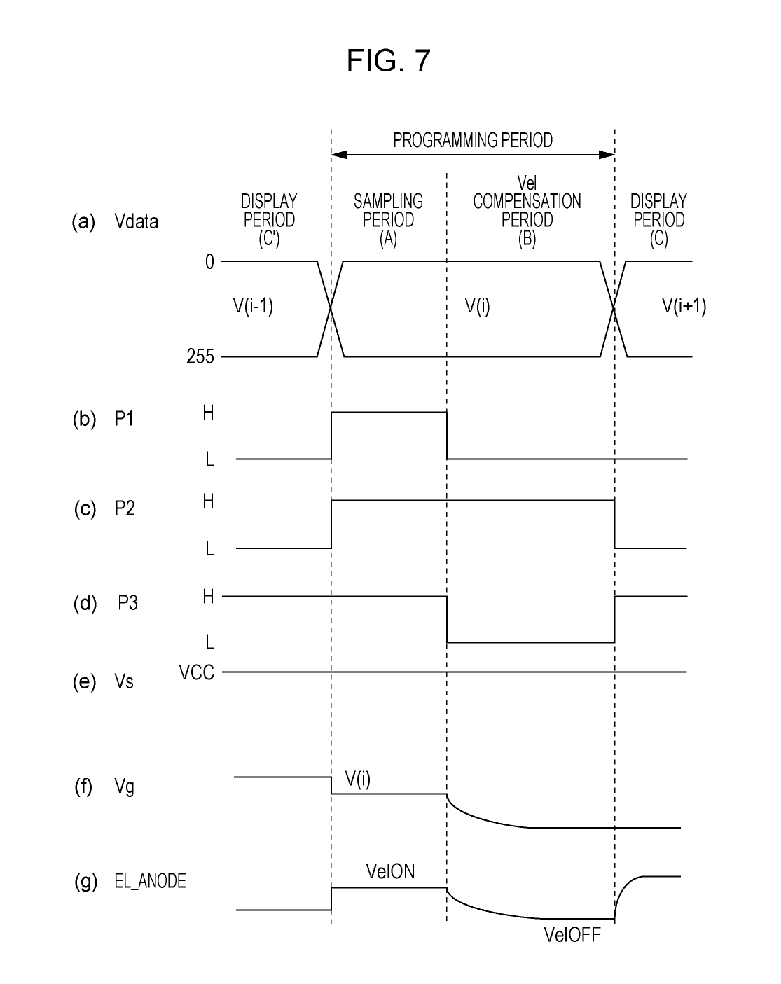

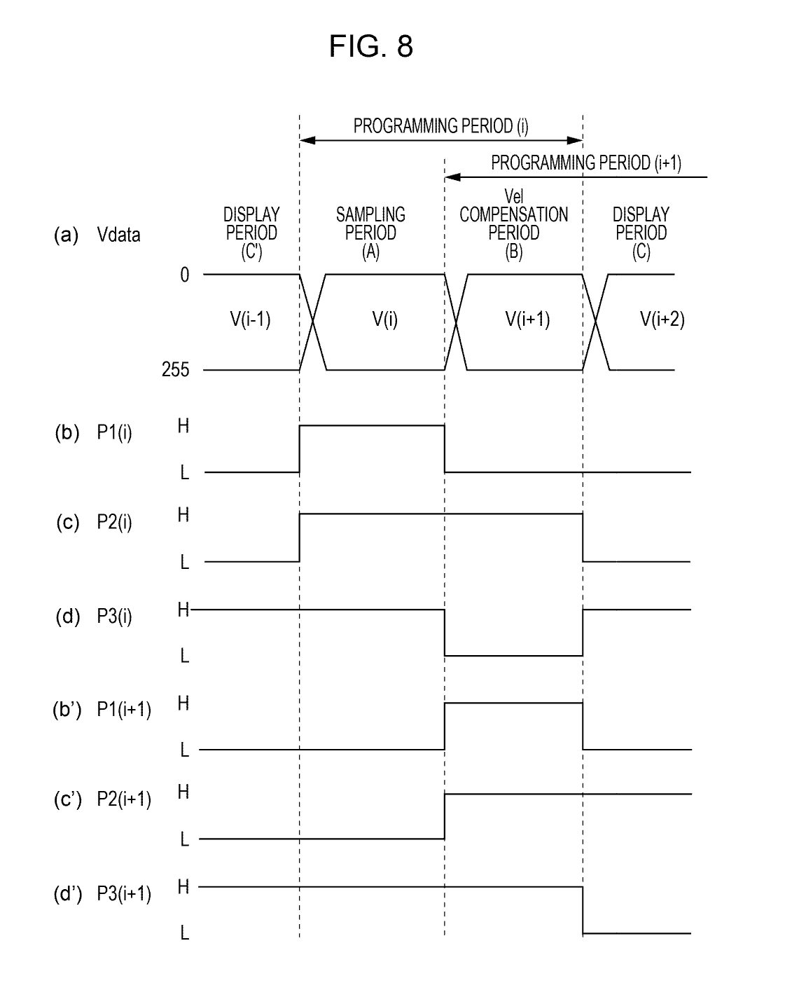

FIG. 7 is a timing chart illustrating an operation of the pixel circuit according to the present embodiment of the invention. In FIG. 7, similar signals, periods, parts, etc. to those in FIG. 3 are denoted by similar reference symbols. The fourth transistor Tr4 turns on or off depending on whether the control signal supplied via the P3 signal line is at the “H” level or “L” level. Operations in the sampling period (A), the Vel compensation period (B), and the display period (C) are similar to those in the first embodiment. The compensation for the reduction in luminance of the light emitting element EL due to degradation is performed in a similar manner to the first embodiment. FIG. 8 is a timing chart illustrating another operation of the circuit shown in FIG. 6. In FIG. 8, (b′), (c′), and (d′) indicate control signals for the (i+1)th row. Although signals (e) to (f) are not shown, these are similar to those in FIG. 7. In FIG. 8, at the beginning of the Vel compensation period (B) for the i-th row, the control signal P1(i+1) on the P1 signal line for a next (i+1)th row and the control signal P2(i+1) on the P2 signal line are switched to the “H” level. At the same time, the voltage on the data line for the (i+1)th row is switched to the data voltage V(i+1), and sampling for the (i+1)th row starts. Operations in the Vel compensation period (B) and display period (C) for the i-th row are similar to those shown in FIG. 7. By performing operations for two rows in parallel in a partial programming period as described above, it becomes possible to reduce the total vertical scanning time.

### Third Embodiment

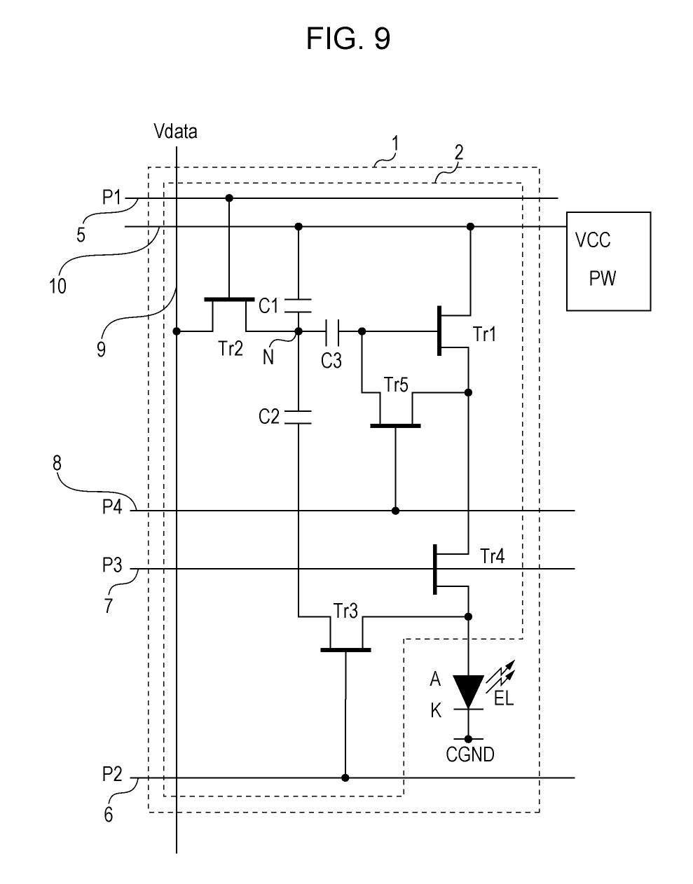

FIG. 9 illustrates an example of a configuration of a pixel circuit 2 including a light emitting element EL according to a third embodiment of the present invention.

The circuit according to the third embodiment shown in FIG. 9 is similar to that shown in FIG. 4 except that the circuit additionally includes a third capacitor C3 connected between the gate of the first transistor Tr1 and the drain of the second transistor Tr2, and additionally includes a fifth transistor Tr5 and a fourth control signal line (P4 signal line). The fifth transistor Tr5 is connected between the gate and the drain of the first transistor, and the fourth control signal line (P4 signal line) is connected to the gate of the fifth transistor Tr5. The other circuit elements and connections thereof are similar to those of the circuit shown in FIG. 4, and similar circuit elements to those in FIG. 4 are denoted by similar reference symbols.

In the present embodiment, the control node N of the second transistor Tr2 is connected to the gate of the first transistor via the third capacitor C3. The fifth transistor functions as a fourth switch provided for an auto zero operation that will be described in detail later.

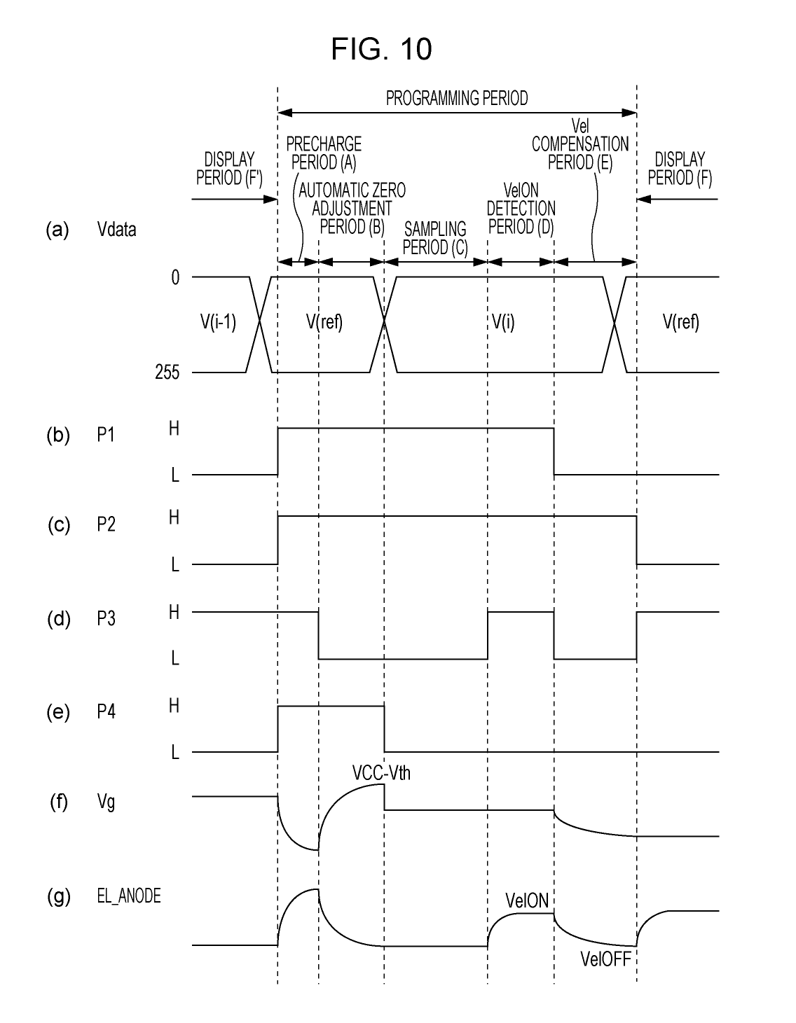

FIG. 10 is a timing chart illustrating an example of an operation of the pixel circuit shown in FIG. 9. As in the first and second embodiments, the operation of each pixel includes a programming period and a display period. The display period is not necessary to have a duty of 100% but may have an arbitrary duty. In the circuit operation according to the present embodiment, the programming period has following five sub periods, i.e., a precharge period (period A), an automatic zero adjustment period (period B), a sampling period (period C), a VelON detection period (period D), and a Vel compensation period (period E).

### Precharge Period (Period A)

In the precharge period (period A), the P1 signal line and the P2 signal line are set to be “H” in level, while the data line is set to be equal to a reference voltage Vref. The reference voltage Vref may be set to an arbitrary constant value independent on the data. The P3 signal line and the P4 signal line are both at the “H” level, and the transistors Tr4 and Tr5 are turned on. The gate and the drain of the transistor Tr1 are connected together so that the transistor Tr1 functions as a diode (hereinafter this connection will be referred to simply as a diode connection).

In this situation, a current flows from the transistor Tr1 connected in the diode connection form into the light emitting element EL, and the gate voltage of the transistor Tr1 becomes equal to the anode voltage of the light emitting element EL. The capacitor C3 is charged to a voltage equal to Vref−Vel.

### Automatic Zero Adjustment Period (Period B)

In the automatic zero adjustment period (period B) following the precharge period (period A), the P3 signal line is set to “L” while the P1 signal line, the P2 signal line, and the P4 signal line are all maintained at “H”. As a result, the transistor Tr2, the transistor Tr3, and the transistor Tr4 turn on and the transistor Tr4 turns off. Thus, the drain current of the transistor Tr1, which was flowing into the light emitting element EL in the previous period (A), flows into the transistor Tr5 in this period (B) thereby discharging the capacitor C3. As a result, the gate potential of the transistor Tr1 rises up and the drain current of the gate voltage decreases. After a particular period has passed, the gate-source voltage of the transistor Tr1 reaches the threshold voltage Vth and the drain current of the transistor Tr1 becomes equal to zero.

As a result, a voltage equal to the difference between the reference voltage Vref on the data line 9 and the gate voltage VCC−Vth of the transistor Tr1 is held by the capacitor C3. That is, the automatic zero adjustment period functions as a period in which the gate-source voltage Vgs of the transistor Tr1 is set to be equal to the threshold voltage Vth thereby making it possible to set the transistor Tr1 so as to provide a driving current independent on a difference in the threshold voltage in a following period.

### Sampling Period (Period C)

In the sampling period (period C), the P4 signal line is set at the “L” level thereby isolating the gate of the transistor Tr1. The data line is switched from Vref to a data voltage Vdata=V(i). The potential on the control node changes in accordance with a change in voltage on the data line, and the change in potential on the control node causes the gate potential of the transistor Tr1 to change via the capacitor C3. As a result, the gate-source voltage Vgs of the transistor Tr1 becomes greater than Vth by Vref−V(i). Thus, the transistor Tr1 is set such that the transistor Tr1 provides a current that is determined only by the data voltage V(i) regardless of unevenness of the threshold voltage or a change in threshold voltage with time.

### VelON Detection Period (Period D)

In the VelON detection period (period D), the P3 signal line is set to “H” to turn on the transistor Tr4 thereby causing a current depending on the data voltage V(i) to flow through the light emitting element EL. Note that the current flowing at this stage does not yet provide exact luminance. The anode voltage VelON of the light emitting element EL is determined by the current flowing through the light emitting element EL and the V-I characteristic depending on degradation of the light emitting element EL at this point of time. In this situation, the voltage applied across the capacitor C2 is equal to the difference between the control node N and the anode of the light emitting element EL, i.e., the difference between V(i) and VelON.

### Vel Compensation Period (Period E)

In the Vel compensation period (period E), the P1 signal line and the P3 signal line are set to “L” thereby turning off the transistor Tr2 and the transistor Tr4. As a result, the current through light emitting element EL is cut off and the anode voltage of the light emitting element EL becomes equal to VelOFF, i.e., the ground potential GND. The change in the anode voltage times a factor depending on the ratio of capacitance of C1 and C2 is transferred via the transistor Tr3 to the common node of the three capacitors (C1, C2 and C3), i.e., the control node N, and this causes the gate voltage of the transistor Tr1 to change via the capacitor C3. As a result, the gate potential of the transistor Tr1 is pulled down by an amount equal to C2/(C1+C2) {×} (VelON−VelOFF), and thus a corresponding increase occurs in the absolute value of the gate-source voltage of the transistor Tr1.

During the process described above, the voltage across the capacitor C3 remains at Vref−Vth, and the voltage corresponding to the data voltage V(i) is still held across the capacitor C1. The current of the transistor Tr1 in the following display period is determined by the gate-source voltage of the transistor Tr1, i.e., the sum of the voltage across the capacitor C1 and the voltage across the capacitor C3. Therefore, in the present embodiment, the combined capacitance of the capacitors C1 and C3 connected in series corresponds to the capacitor C1 in the first embodiment described above.

### Display Period (Period F)

In the display period (period F) after the programming period including the sub-periods A to E described above, the P2 signal line is set to “L” to turn off the transistor Tr3. As a result, the feedback loop is cut off and thus any further change in the anode voltage no longer causes a change in the gate voltage of the transistor Tr1. At the same time as the setting of the P2 signal line, the P3 signal line is set to “H” thereby turning on the transistor Tr4. As a result, light emission starts. The anode voltage of the light emitting element EL becomes higher than the voltage VelON appearing in the VelON detection period (period (D), and the current supplied from the transistor Tr1 increases by an amount corresponding to the increase in the anode voltage of the light emitting element EL. Thus, the current supplied from the transistor Tr1 to the light emitting element EL becomes greater than that in the sampling period.

When the display period starts for a particular programmed row (i-th row), the programming period for a next row ((i+1)th row) starts. That is, when viewed with respect to the next row, the display period (F) for the i-th row starts at the substantially same time as the start of the precharge period for the (i+1)th row. Note that in the display period (F′), the data voltage Vdata is the data voltage (V(i−1)) for the previous row ((i−1)th row).

The compensation for the degradation of the light emitting element EL is performed in a similar manner to the first embodiment described above. The parameters are set such that the increase in the current of the transistor Tr1 causes the luminance to increase by an amount equal to the amount of reduction in luminance due to the degradation of the light emitting element EL thereby compensating for the reduction in the luminance due to the time-dependent degradation of the light emitting element EL. More specifically, the setting is accomplished by properly selecting the ratio of the capacitance of the capacitors C1 and C2.

In the present embodiment, even if there is a difference in threshold value among a plurality of first transistors, it is possible to display an image without being influenced by the difference in threshold value by setting the gate-source voltage in the automatic zero adjustment period so as to delete the effect of the difference in the threshold value. Furthermore, in the present embodiment, the difference in the anode voltage between the two states, i.e., the state in which no current is passed through the light emitting element EL and the state in which the current is passed through the light emitting element EL such that the exactly expected luminance is obtained is fed back to the gate voltage of the driving transistor in the pixel so that the current flowing through the light emitting element EL is increased to increase the luminance by an amount equal to the reduction in luminance due to degradation thereby compensating for the reduction in the luminance due to the degradation on a pixel-by-pixel basis.

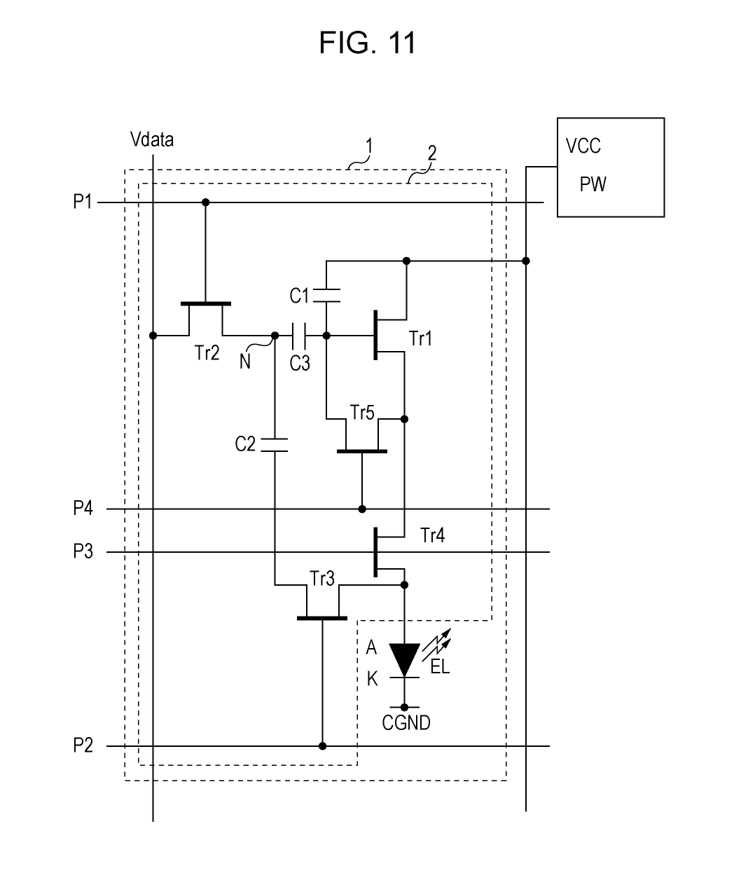

FIG. 11 illustrates an example of a modification of the pixel circuit shown in FIG. 9. In the pixel circuit shown in FIG. 9, one end of the capacitor C1 is connected to the source of the transistor Tr2. In the pixel circuit shown in FIG. 11, in contrast, one end of the capacitor C1 is connected to the gate of the transistor Tr1. Except for the above, the pixel circuit shown in FIG. 11 is similar in configuration to that shown in FIG. 9. In this circuit, unlike the circuit shown in FIG. 9, the gate voltage given by sampling the data voltage on the data line is adjusted by the ratio of C1 to C3, and the voltage fed back from the anode voltage of the light emitting element EL to the gate voltage of the transistor Tr1 is adjusted by the ratio of the combined capacitance of C2 and C3 to the capacitance of C1. The current flowing through the light emitting element EL is determined by the voltage across the capacitor C1.

In the first to third embodiments of the present invention described above, the display apparatus includes a light emitting element EL, a transistor that adjusts a current supplied to the light emitting element EL, a capacitor that holds a voltage corresponding to the current supplied by the transistor to the light emitting element EL, a first switch that operates to capture a signal voltage on a data line into a pixel circuit and hold it in the pixel circuit, a second switch disposed in the middle of a current path via which the current is provided to the light emitting element EL and operates to cut off the current, and a third switch that operates to feed back a change in the voltage across the light emitting element EL to the pixel circuit via a capacitor. The second switch is generally disposed within the pixel circuit. However, the second switch may be disposed outside the pixel circuit as in the first embodiment in which the second switch SW is disposed outwardly between the power supply line and the constant voltage circuit.

Table shown below summarizes the correspondence of circuit elements among different embodiments (the first embodiment (FIG. 1), the second embodiment (FIG. 6), the third embodiment (FIG. 9), and the modification of the third embodiment (FIG. 11)).

TABLE

| | | | | Modification |
|---|---|---|---|---|
| | First | Second | Third | of third |
| | embodiment | embodiment | embodiment | embodiment |
| | (FIG. 1) | (FIG. 6) | (FIG. 9) | (FIG. 11) |
| TR that | First | First | First | First |
| adjusts | transistor | transistor | transistor | transistor |
| current | (Tr1) | (Tr1) | (Tr1) | (Tr1) |
| Capacitor | First | First | Series | First |
| that holds | capacitor | capacitor | connection | capacitor |
| voltage | (C1) | (C1) | of first | (C1) |
| corresponding | | | and third | |
| to current | | | capacitors | |
| First switch | Second | Second | Second | Second |
| that captures | transistor | transistor | transistor | transistor |
| signal | (Tr2) | (Tr2) | (Tr2) | (Tr2) |
| voltage | | | | |
| Second switch | Switch | Fourth | Fourth | Fourth |
| that cuts off | (SW) on | transistor | transistor | transistor |
| current | power | (Tr4) | (Tr4) | (Tr4) |
| | supply | | | |
| | line | | | |
| Third switch | Third | Third | Third | Third |
| that feeds | transistor | transistor | transistor | transistor |
| back voltage | (Tr3) | (Tr3) | (Tr3) | (Tr3) |

The first switch and the associated control signal line for controlling the first switch form a circuit unit that operates to capture the signal voltage on the data line into the pixel circuit and hold it therein. This circuit unit refers to as a first circuit unit. The first circuit unit has the function of sampling the signal voltage on the data line. The first switch may connect the data line directly to the pixel circuit or indirectly via a capacitor.

The third switch and the associated control signal line for controlling the third switch form a second circuit unit that operates to feed back a change in voltage across the light emitting element EL to the pixel circuit via a capacitor. More specifically, the change in the voltage across the light emitting element EL is added to the gate voltage of the driving transistor that controls the current supplied to the light emitting element EL thereby providing a new gate voltage that is actually applied to the gate of the driving transistor. In the embodiments described above, the second circuit unit is realized by a series connection of a capacitor and a switch. Alternatively, the second circuit unit may be configured in a more complicated manner to input the voltage across the light emitting element EL, reduce the input voltage by a proper factor, and add the resultant voltage to the gate voltage.

### Fourth Embodiment

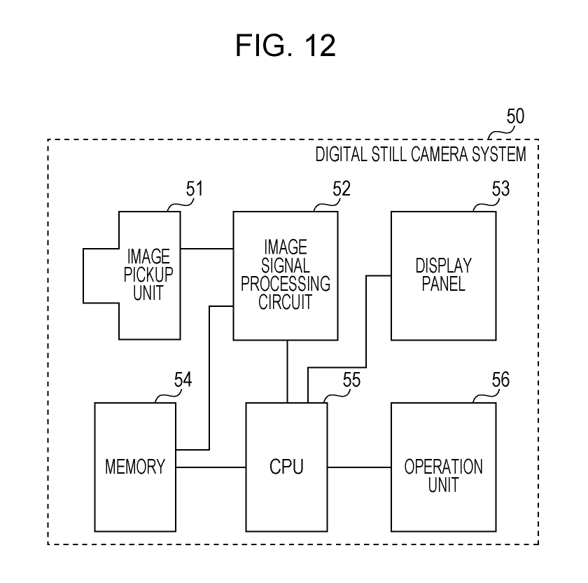

FIG. 12 is a block diagram illustrating a digital still camera system including a display apparatus according to an embodiment of the present invention. An image captured by an image pickup unit 51 or an image stored in a memory 54 is processed by an image signal processing circuit 52 and displayed on a display panel 53. In accordance with a command input via an operation unit 56, a CPU 55 controls the image pickup unit 51, the memory 54, the image signal processing circuit 52, and other parts to perform capturing, recording, playing-back, or displaying of an image.

The display apparatus including light emitting elements of the self-emitting type arranged in the form of a matrix and the method of driving it according to one of the embodiments of the invention described above may find applications such as an active matrix display apparatus configured to display an image using light emitting elements of the self-emitting type such as EL (electroluminescence) elements that are turned on and off during particular periods under the control of an electric circuit.

The display apparatus may be used, for example, to realize an information display apparatus used in a portable telephone, a portable computer, a still camera, a video camera, etc. The display apparatus may also be used to achieve two or more functions described above. The information display apparatus may include an information input unit. In the case of a portable telephone, the information input unit may be an antenna. In the case of a PDA or a portable computer, the information input unit may include a unit that functions as an interface with a network.

In the case of a still camera or a video camera, the information input unit may include a sensor such as a CCD sensor, a CMOS sensor, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-289726 filed Dec. 21, 2009 and No. 2010-256309 filed Nov. 16, 2010, which are hereby incorporated by reference herein in their entirety.

What is claimed is:

1. A method of driving a display apparatus including a light emitting element including a light emitting layer disposed between a pair of electrodes, a pixel circuit connected to a data line and a power supply line, a constant voltage power supply connected to the power supply line, and a second switch disposed in a current path from the constant voltage power supply to one of the electrodes of the light emitting element, wherein the pixel circuit includes a transistor a source of which is connected to the power supply line and which supplies a current from its drain to the one of the electrodes of the light emitting element, a first capacitor one end of which is connected directly or indirectly via a capacitor to a control node connected directly or indirectly via a capacitor to a gate of the transistor, a first switch connected between the data line and the control node, and a series connection of a third switch and a second capacitor connected between the control node and the one of the electrodes of the light emitting element, the method comprising:
turning on the first switch, the second switch, and the third switch thereby supplying a current to the light emitting element, setting the control node to have a voltage equal to a data voltage of the data line, and holding, across the second capacitor, a potential difference between the one of the electrodes of the light emitting element and the control node;
turning off the second switch thereby cutting off the current flowing through the light emitting element whereby a change occurs in potential of the one of the electrodes of the light emitting element and this change in the potential of the one of the electrodes of the light emitting element produces a change in the potential of the control node via the second capacitor; and
turning off the third switch and turning on the second switch thereby supplying a current corresponding to a gate potential of the transistor to the light emitting element.
